(19) United States
(12) Patent Application Publication
(10) Pub. No.: US 2011/0173223 A1
(43) Pub. Date: Jul. 14, 2011

(54) METHODS AND APPARATUS TO USE A NETWORK REPOSITORY AS A PROXY TO EXCHANGE CONVERGED ADDRESS BOOK SERVICE REQUESTS AND RESPONSES

(76) Inventors: Suresh Chitturi, Plano, TX (US); Brian E. McColgan, Toronto (CA)

(21) Appl. No.: 12/839,999

(22) Filed: Jul. 20, 2010

Related U.S. Application Data
(60) Provisional application No. 61/227,057, filed on Jul. 20, 2009.

(51) Int. Cl. G06F 17/30

(52) U.S. Cl. 707/769; 707/E17.014

(57) ABSTRACT

Methods and apparatus to use a network repository as a proxy to exchange converged address book service requests and responses are disclosed. An example method disclosed herein comprises storing, at a network repository of a converged address book (CAB) service, a request identifying a CAB service feature, and obtaining from said network repository, a response associated with said request, said request and said response being stored in a document conforming to a CAB service handler application usage.

### RELATED APPLICATION

This patent claims priority from U.S. Provisional Application Ser. No. 61/227,057, entitled “Methods and Apparatus to Use a Network Repository as a Proxy to Exchange Converged Address Book Service Requests and Responses” and filed on Jul. 20, 2009. U.S. Provisional Application Ser. No. 61/227,057 is hereby incorporated by reference in its entirety.

### FIELD OF THE DISCLOSURE

This disclosure relates generally to converged address book services and, more particularly, to methods and apparatus to use a network repository as a proxy to exchange converged address book service requests and responses.

### BACKGROUND

Modern user computing devices provide many applications implementing features that utilize personal contact information obtained from one or more address books. A typical address book contains a list of contact entries, with each contact entry comprising a set of contact information. Such information could include, but is not limited to, a name, a physical address, an email address, a telephone number, a personal identification number, an instant messaging identifier, etc., which enables one user to contact another user. Additionally, an address book system may maintain and manage a computing device user's own personal contact information. The Open Mobile Alliance (OMA) is standardizing a Converged Address Book (CAB) enabler to permit users to manage (e.g., add, modify, delete, etc.), publish, subscribe, import, search and share contact information among various computing devices, users, and applications.

### BRIEF DESCRIPTION OF THE DRAWINGS

FIG. 1 is a block diagram of an example converged address book (CAB) system capable of exchanging and processing service requests and responses using a network repository as a proxy.

FIG. 2 is a block diagram illustrating example implementations of a CAB client, a CAB server and a network repository included in the example CAB system of FIG. 1.

FIGS. 3A-B each illustrate a respective example message sequence diagram illustrating operation of the example CAB client, the example CAB server and the example network repository of FIG. 2 to exchange and process service requests and responses.

FIG. 4, which comprises FIGS. 4A-D, illustrates an example extensible markup language (XML) schema to use in formatting service requests and responses exchanged according to the example message sequence diagrams of either or both of FIGS. 3A-B.

FIGS. 5-7 each illustrate an example XML data structures for CAB service requests and responses formatted according to the example XML schema of FIG. 4.

FIG. 8 illustrates a flowchart representative of an example process that may be performed to implement the example CAB client of FIG. 2.

FIGS. 9A-B each illustrate a respective example flowchart representative of an example process that may be performed to implement the example CAB server of FIG. 2.

FIG. 10 is a block diagram of an example computing device that may execute example machine readable instructions to implement any or all of the processes of FIGS. 8, 9A and 9B to implement any or all of the example CAB client of FIG. 2, the example CAB server of FIG. 2 and the example CAB system of FIG. 1 or 2.

### DETAILED DESCRIPTION

Although the following discloses example methods and apparatus including, among other components, software executed on hardware, it should be noted that such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

Currently, there are a wide variety of address book systems employing different data formats and communication protocols that are often not interoperable among different computing devices or applications. The Open Mobile Alliance (OMA) is an example of one organization working to define a global standard for interoperable address book management and use. In particular, the OMA is standardizing a converged address book (CAB) enabler to permit users to manage (e.g., add, modify, delete, etc.), publish, subscribe, import, search and share contact information among various computing devices, users, and applications. As used herein, and defined by the OMA, the term “enabler,” in general, refers to any system, technology, etc., supporting development, deployment or operation of a service, such as a CAB service. Example CAB services include, but are not limited to, an address book management service to manage (e.g., add, modify, delete, etc.) address book data stored in a network repository, a personal contact card management service to manage a user's own personal contact information stored in the network repository, a search service to allow searching for available contact information internal or external to the CAB system, a contact share service to allow sharing of contact information among users, a contact subscription service to allow a user to subscribe to changes in contact information maintained by other users, and an import non-CAB address book service to allow for the import of legacy address book information (e.g., from non-CAB address book systems).

Presently, an OMA-compliant CAB system provides a direct interface between a CAB client operating on a user's device and a CAB server in communication with the network data repository to synchronize and manage information in the network (e.g., such as address book data, personal contact card data, as well as other forms of CAB user data, such as user preferences and policies) with read and write operations, among others, which may be relatively simple and implemented using, for example, the OMA data synchronization (DS) SyncML protocol. Other messaging operations, which may be more complex than the foregoing-mentioned read and write operations, to support user requests to invoke other CAB service features, such as the contact share service, the contact subscription service and the import non-CAB address book service, as well as to support their associated responses, may be performed via a network repository acting as proxy instead of directly between the CAB client and the CAB server. However, at present, the actual implementation of the proxy-based exchange of CAB service requests and responses in an OMA-compliant CAB system is undefined.

Accordingly, example methods and apparatus to use a network repository as a proxy to exchange CAB service requests and responses are described herein. The methods and apparatus described herein implement an example CAB service handler messaging framework for exchanging messages between a CAB client and a network repository to enable the CAB client to store service requests at a network repository for later access or retrieval by a CAB server, and for a CAB client to later retrieve associated service responses stored at the network repository by the CAB server. The example CAB service handler messaging framework also supports exchanging messages between a CAB server and the network repository to enable the CAB server to retrieve service requests stored at the network repository by the CAB client, and to store associated service responses at the network repository for retrieval by the CAB client.

In an example implementation, the network repository is implemented by an extensible markup language (XML) document management server (XDMS). In such an example, the methods and apparatus described herein implement an XML document management (XDM) application usage specifying the syntax/schema for formatting the service requests in XML for storage in one or more XML documents at the XDMS. The example XDM application usage is referred to as the CAB service handler application usage and, in an example implementation, supports individual and/or composite service requests which are decomposed by the XDMS proxy into multiple, individual service requests for similar or different services chained or otherwise aggregated together to implement a particular composite service request (e.g., such as a CAB contact share service feature on behalf of a CAB client). Thus, the CAB service handler messaging framework and the associated CAB service handler application usage can decouple the CAB client and the CAB server such that the CAB client needs to spe'cify a minimal amount of information and have limited interaction with the XDMS, in terms of message requests and message payloads, whereas the XDMS and the CAB server perform the bulk of the processing and have more extensive interaction. In this way, at least some example CAB clients can be implemented as thin clients imposing only a small footprint (e.g., in terms of processing, memory requirements, and network bandwidth) on the user's computing device and the associated network.

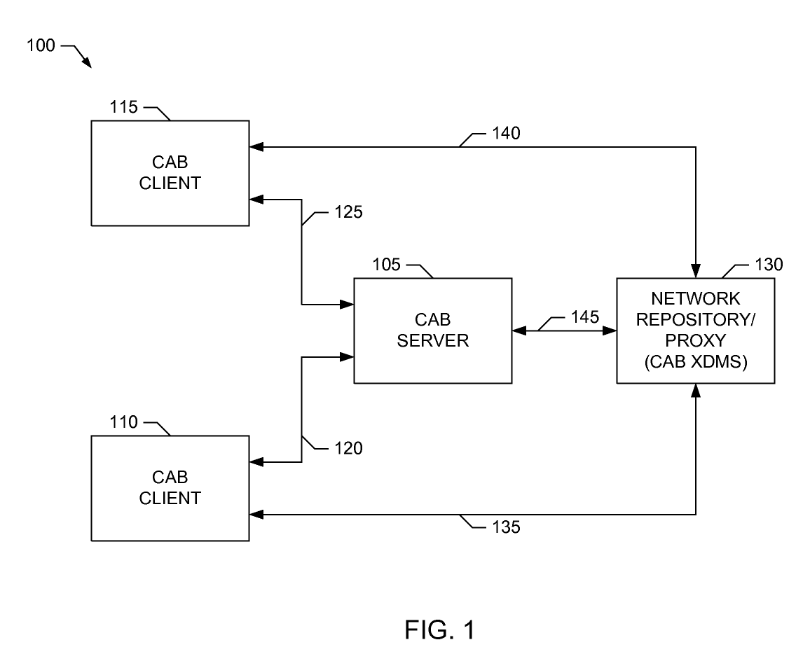

Turning to the figures, an example CAB system 100 capable of using a network repository as a proxy to exchange CAB service requests and responses is shown in FIG. 1. The CAB system 100 includes an example CAB server 105 in communication with a network repository 130 storing CAB contact information used by example CAB clients 110 and 115. As described in greater detail below, the CAB server 105 and the CAB clients 110 and 115 implement the methods and apparatus described herein to exchange. CAB service requests and associated responses via a network repository acting as a proxy or, in other words, acting as a proxy server or gateway. Each of the example CAB clients 110 and 115 can be implemented in a respective user computing device to provide CAB functionality to applications operating on the user device. Examples of user devices that can implement the CAB clients 110 and 115 include, but are not limited to, mobile communication devices, mobile computing devices, or any other device capable of accessing information over a wired or wireless network, such as mobile smart phones (e.g., a BLACKBERRY® smart phone), personal digital assistants (PDA), laptop/notebook/netbook computers, desktop computers, set-top boxes, etc.

The CAB server 105 implements one or more CAB services for operating on stored CAB information. For example, the CAB server 105 implements an address book management service, a personal contact card management service, a search service, a contact share service, a contact subscription service and an import non-CAB address book service as described above. In the illustrated example, and as specified by the OMA, the CAB system includes respective direct interface 120 and 125 between the CAB server 105 and the CAB clients 110 and 115 to support the relatively basic interactions necessary to synchronize and manage information in the network (e.g., such as address book data, personal contact card data, as well as other forms of CAB user data, such as user preferences and policies) with simple read and write operations, among others, using the OMA DS SyncML protocol.

However, other services, such as the contact share service, the contact subscription service and the import non-CAB address book service, require relatively more complex messaging (e.g., more complex than read/write-type messaging) to allow a user device implementing a CAB client to send a request to a CAB server to invoke a service, to then allow the CAB server to process the request, and then to subsequently allow the CAB client to receive an associated response to the request. For example, the CAB client 110 may direct a request towards the CAB server 105 to invoke the contact share service to cause contact information for one or more contacts associated with the CAB client 110 to be shared with the CAB client 115.

In another example, the CAB client 110 may direct a request towards the CAB server 105 to invoke the contact subscription service to allow the CAB client 110 to be notified when specified contact information associated with the CAB client 115 is modified. In yet another example, the CAB client 110 may direct a request towards the CAB server 105 to invoke the import non-CAB address book service to import legacy information stored in a non-CAB address book system (not shown) into the CAB system.

The example CAB system 100 of FIG. 1 includes a network repository 130 to exchange messaging associated with CAB service requests and responses according to the methods and apparatus described herein. In the illustrated example, the network repository 130 is implemented as a CAB XDMS 130 for storing and managing XML documents used to exchange information (e.g., requests and responses) between the CAB server 105 and the CAB clients 110 and 115. In the context of exchanging messaging associated with CAB service requests and responses, the CAB clients 110 and 115 store user requests at the CAB XDMS 130 via respective indirect (or proxy) interfaces 135 and 140. As a result, the CAB server 105 is notified of corresponding CAB server targeted requests or is able to directly retrieve CAB server targeted requests corresponding to CAB client user requests through a proxy interface 145. The corresponding response data is then provided by the CAB server 105 to the CAB XDMS 130 via the proxy interface 145. The CAB clients 110 and 115 then retrieve the stored response data corresponding to their respective CAB client user requests from the CAB XDMS 130 and/or are automatically notified of the stored response data corresponding to their respective CAB client user requests by the CAB XDMS 130 via the respective interfaces 135 and 140. As described in greater detail below, a CAB user request (also referred to as a CAB user service request) stored at the CAB XDMS 130 by the CAB client 110 or 115 may correspond directly to a similar CAB server request (also referred to as a CAB server service request) provided to the CAB server 105 by the CAB XDMS 130, or may be transformed by the CAB XDMS 130 into one or more CAB server requests (also referred to as CAB server primitives) that together implement the CAB user request.

As mentioned above, the CAB system 100 and, more specifically, the CAB server 105, the CAB clients 110 and 115 and the CAB XDMS 130 prepare and process CAB service requests and responses according to an example CAB service handler application usage. The CAB service handler application usage is a special XDM application usage specifying the schema (e.g., syntax) of the service requests, as well as the semantics (e.g., meaning, behavior, and possibly limits) of the client service requests. The CAB service handler application usage employed by the CAB system 100 also specifies the schema for storing responses and other processing results associated with the CAB service requests such that the CAB clients 110 and 115 can be made aware of the status of each of their respective requests.

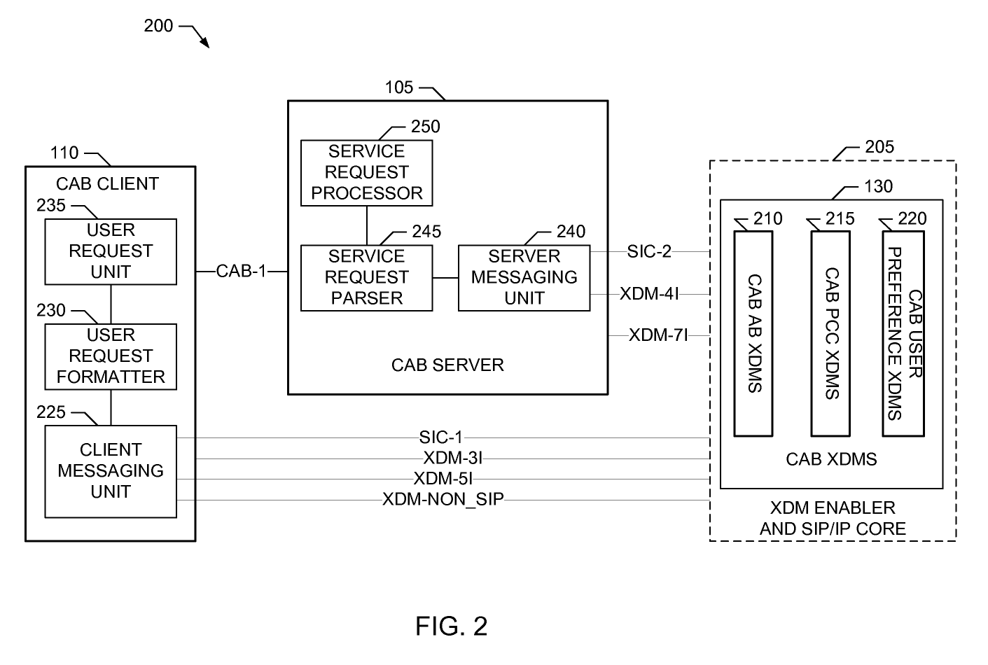

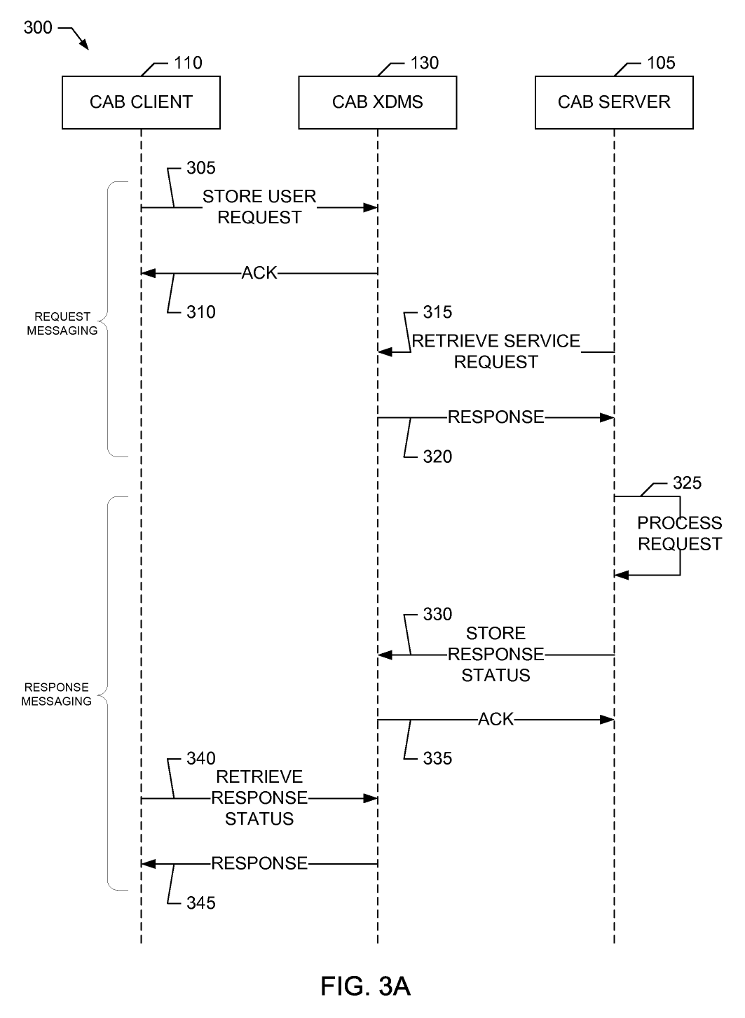

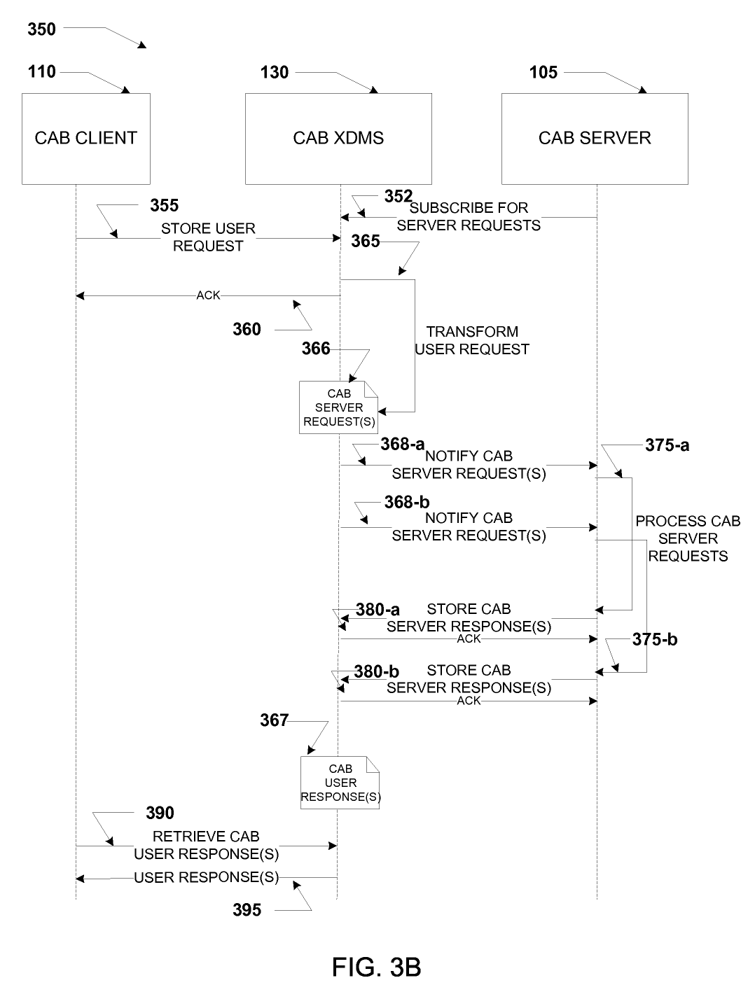

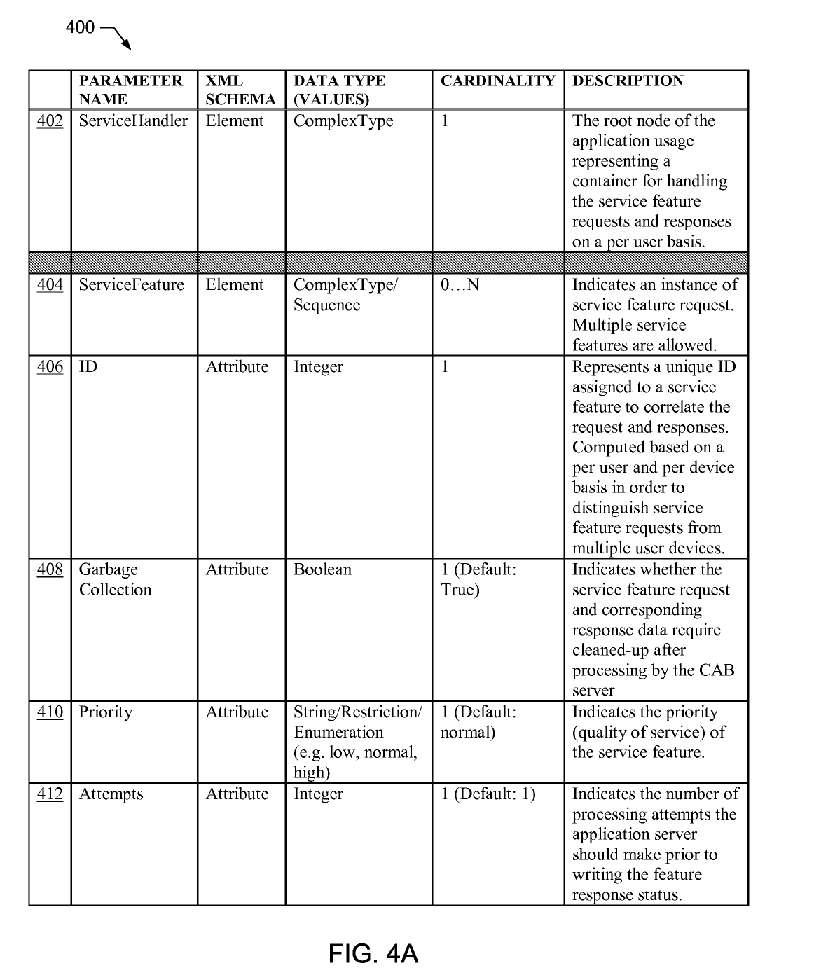

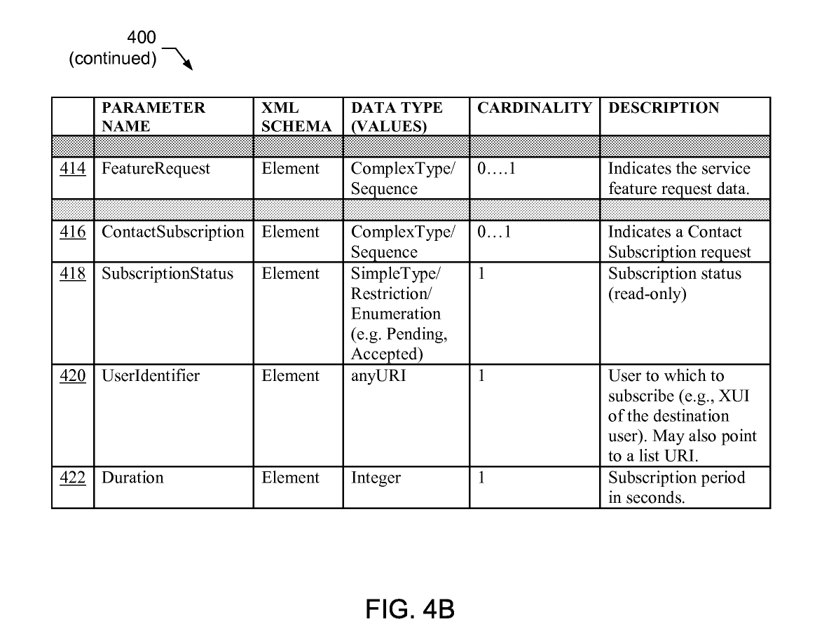

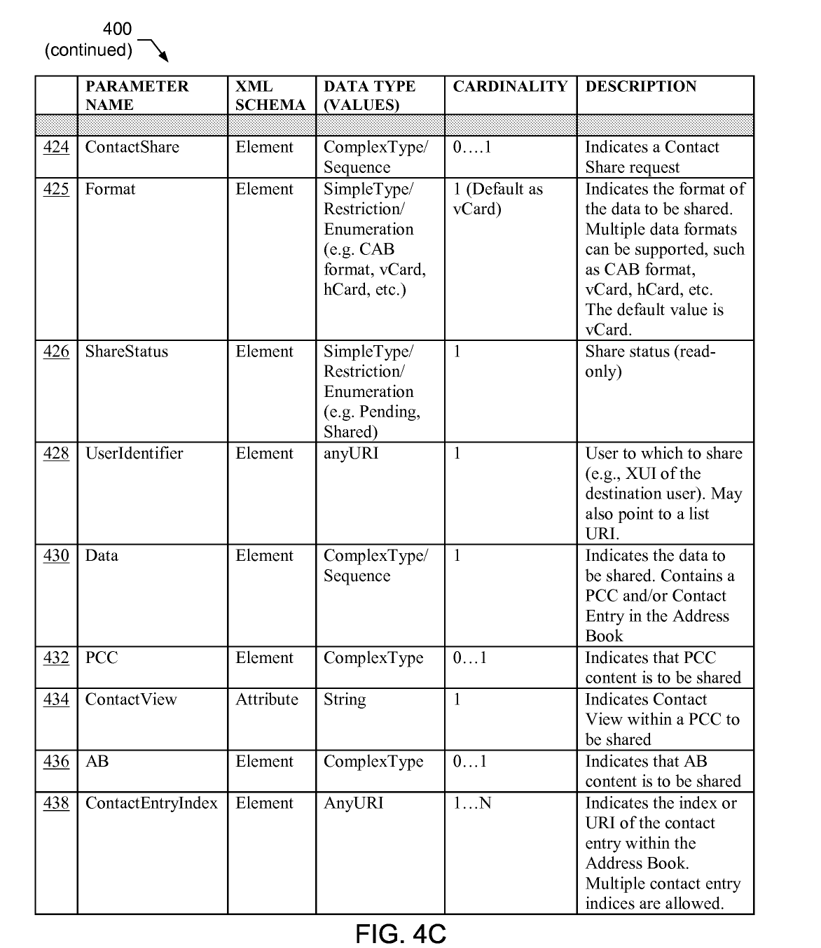

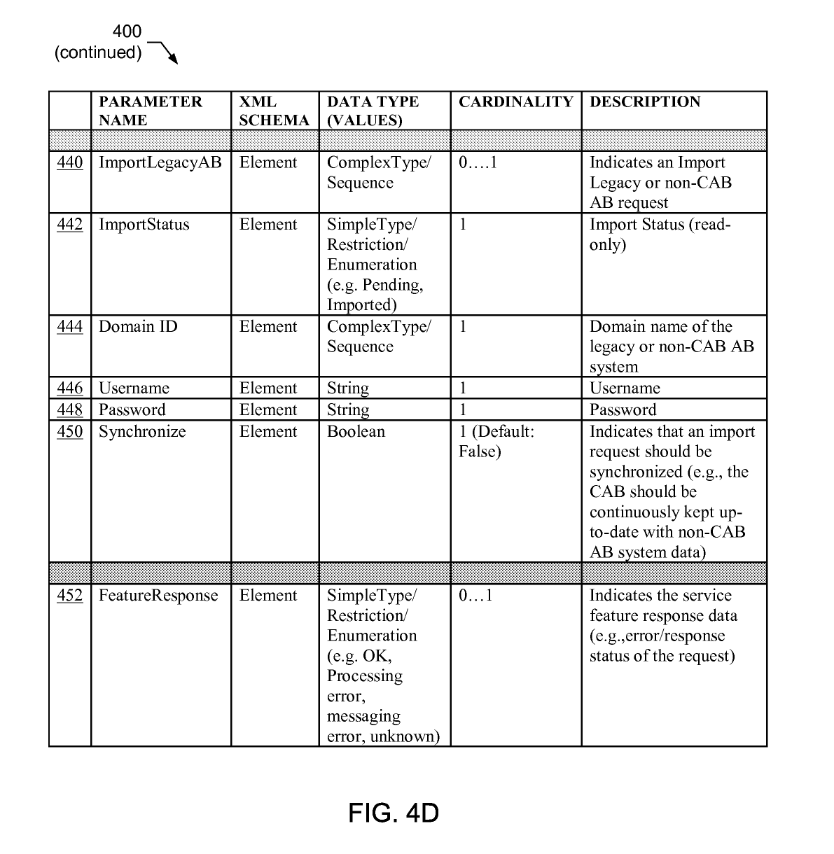

Example implementations of the CAB server 105, the CAB client 110, and the CAB XDMS 130 are illustrated in FIG. 2. Examples of messaging conveyed via the interfaces 135 and 145 are illustrated in FIGS. 3A-B. An example CAB service handler application usage is illustrated in FIGS. 4A-D.

An example CAB system 200 including example implementations of the CAB server 105, the CAB client 110, and the CAB XDMS 130 of FIG. 1 is illustrated in FIG. 2. As shown in the CAB system 200 of FIG. 2, the CAB client 110 is communicatively coupled with the CAB server 105 via a CAB-1 interface, the CAB client 110 is communicatively coupled with the CAB XDMS 130 via SIC-1, XDM-3i, XDM-5i and XDM-NON_SIP interfaces, and the CAB server 105 is communicatively coupled with the CAB XDMS 130 via SIC-2, XDM-4i and XDM-7i interfaces. Examples of the CAB-1, SIC-1, SIC-2, XDM-3i, XDM-4i, XDM-5i and XDM-7i interfaces are defined in the OMA's “Converged Address Book Architecture,” Draft Ver. 1.0 (Jun. 24, 2009), which is publicly available and incorporated by reference herein in its entirety. With reference to FIG. 1, the direct interface 120 between the CAB client 110 and the CAB server 105 can be implemented by the CAB-1 interface, the indirect interface 135 between the CAB client 110 and the CAB XDMS 130 can be implemented by either or both of the SIC-1 interface employing the session initiation protocol (SIP) and the XDM-3i interface employing the XML configuration access protocol (XCAP) based on the hypertext transfer protocol (HTTP), and the indirect interface 145 between the CAB server 105 and the CAB XDMS 130 can be implemented by either or both of the SIC-2 interface employing SIP and the XDM-4i interface employing XCAP/HTTP.

Also, as shown in the CAB system 200 of FIG. 2, the CAB XDMS 130 is implemented according to the OMA XDM enabler specifications and is included in a core network 205 functional component supporting SIP and Internet protocol (IP) communications. Additionally, the CAB XDMS 130 includes one or more constituent XDMSs to store, manage, transform, share and otherwise process contact information among CAB servers and CAB clients. For example, the CAB XDMS 130 includes a CAB address book (AB) XDMS 210 dedicated to address book information, a CAB personal contact card (PCC) XDMS 215 dedicated to a user's own personal contact information and a CAB user preference XDMS 220 dedicated to storing user preferences and supporting service customization. More detailed descriptions of the functionality supported by the CAB AB XDMS 210, the CAB PCC XDMS 215 and the CAB user preference XDMS 220 are provided in OMA's “Converged Address Book Architecture” referenced above. In at least some example implementations, the CAB service handler application usage mentioned above and described in greater detail below in conjunction with FIGS. 4A-D can be implemented by any one of the constituent XDMSs 210-220 included in the CAB XDMS 130 (e.g., such as the CAB user preference XDMS 220). Alternatively, the CAB service handler application usage could be implemented by a separate dedicated constituent XDMS (not shown). Also, in at least some example implementations, the CAB service handler application usage can be divided into multiple application usages, such as one for storing requests and another for storing response data. Furthermore, it is possible to define a separate application usage for each service feature (e.g., such as a separate application usage for each of the contact subscription, contact share and import non-CAB address book features).

To exchange messaging associated with CAB service requests and responses via the CAB XDMS 130 (acting as a proxy), the CAB client 110 of FIG. 2 includes an example client messaging unit 225 to send user requests to the CAB XDMS 130 and to receive associated responses from the CAB XDMS 130. For example, the client messaging unit 225 can be configured to send user requests and receive associated responses using SIP messaging conveyed via the SIC-1 interface or non-SIP messaging via the XDM-NON_SIP interface. Additionally or alternatively, the client messaging unit 225 can be configured to send user requests and receive associated responses using XCAP/HTTP/XDCP messaging conveyed via the XDM-3i interface. For example, the client messaging unit 225 can be implemented by an XDM client (XDMC) configured to store CAB server targeted requests via the XDM-3i interface and retrieve or obtain associated responses using SIP messaging conveyed via the SIC-1, XDM-NON_SIP or XDM-3i interfaces. Examples of the messaging sent and received by the client messaging unit 225 are illustrated in FIGS. 3A-B and described in greater detail below.

The CAB client 110 of FIG. 2 also includes a user request formatter 230 to format user service requests and retrieve associated responses according to an example CAB service handler application usage illustrated in FIGS. 4A-D and described in greater detail below. Additionally, the CAB client 110 includes a user request unit 235 to generate CAB user requests based on inputs received from, for example, a user or an application executing on the user device implementing the CAB client 110. To generate a user request, the user request unit 235 may also specify a priority, such as low, normal, high, etc., to indicate the importance of the generated request relative to previous or future service requests, or both. Additionally or alternatively, the user request unit 235 may specify a number of attempts or retries to be performed by the CAB server 105, if necessary, when processing the request (e.g., to handle scenarios in which errors occur during processing). The user request unit 235 also provides any responses associated with the generated CAB user service requests to the respective user or application. Such responses can also include status or error handling information, or both, related to processing of the request by the CAB server 105. For example; data processing, messaging errors, etc., may occur during processing of a service request.

In at least some example implementations, the user request unit 235 can initiate a garbage collection operation to delete previous service requests stored at the CAB XDMS 130 or to request garbage collection on behalf of CAB client 110 at the CAB XDMS 130. Generally, to preserve memory resources, user service requests are not to be stored permanently in the CAB XDMS 130. Accordingly, the user request unit 235 can be configured to automatically (e.g., periodically, based on occurrence of an event, according to a policy, etc.) trigger sending of an appropriate clean-up message to the CAB XDMS 130 to cause expired user service requests to be deleted. Service requests may be considered to be expired, for example, after a certain period of time has expired, after a response to the request has been retrieved by the CAB client 110, etc. Additionally or alternatively, such a garbage collection operation may be initiated by the CAB Server 105 or the CAB XDMS 130 automatically without the intervention of the CAB client 110 based on specified configurations or policies, as described below.

To exchange messaging associated with CAB service requests and responses via the CAB XDMS 130, the CAB server 105 of FIG. 2 includes an example server messaging unit 240 to retrieve CAB server requests from the CAB XDMS 130 corresponding with a CAB client 110 user request (e.g., such as a server request corresponding directly to a similar user request stored by the CAB client 110 or multiple server requests (e.g., primitives) determined by transforming the stored user request) and to send associated responses to the CAB XDMS 130. For example, the server messaging unit 240 can be implemented by an XDM client (XDMC) configured to retrieve CAB server requests and send associated responses using SIP messaging conveyed via the SIC-2 interface. Additionally or alternatively, the server messaging unit 240 can be implemented by an XDMC configured to retrieve CAB server requests and send associated responses using XCAP/HTTP messaging conveyed via the XDM-4I interface. Examples of the messaging sent and received by the server messaging unit 240 are illustrated in FIGS. 3A-B and described in greater detail below.

The CAB server 105 of FIG. 2 also includes a service request parser 245 to parse server requests retrieved from the CAB XDMS 130 and return associated responses, including status or error handling information, or both, according to the example CAB service handler application usage illustrated in FIGS. 4A-D and described in greater detail below. In at least some example implementations, the server messaging unit 240 and the service request parser 245 can be implemented by a single XDMC.

Additionally, the CAB server 105 includes a service request processor 250 to process the retrieved CAB server requests according to the appropriate CAB service (e.g., such as the contact share service, the contact subscription service the import non-CAB address book service, etc.) related to each request. For example, the service request processor 250 can be implemented by corresponding functions, such as the Contact Subscription Function, the Contact Share Function or the Interworking Function defined in OMA's “Converged Address Book Architecture” referenced above. Furthermore, the service request processor 250 can prioritize processing of multiple service requests according to priorities, such as low, normal, high, etc., specified in the requests. Additionally or alternatively, the service request processor 250 can retry processing of a particular user service request (e.g., to handle scenarios in which errors occur during processing) if retries are permitted by the service request.

In at least some example implementations, the service request processor 250 performs a garbage collection operation to initiate or signal a delete operation for previous service requests stored at the CAB XDMS 130. As mentioned above, to preserve memory resources, user service requests are not to be stored permanently in the CAB XDMS 130. Accordingly, the service request processor 250 (in addition or as an alternative to the user request unit 235) can be configured to automatically (e.g., periodically, based on occurrence of an event, according to a policy, etc.) trigger sending of an appropriate clean-up message to the CAB XDMS 130 to cause any expired user service requests to be deleted.

Although the example methods and apparatus are described herein in the context of CAB systems 100 and 200 of FIGS. 1 and 2, respectively, the example methods and apparatus may additionally or alternatively be implemented in connection with any system that utilizes an XDMS or other server as a proxy or intermediary for exchanging messaging or other communications between a client and an application server.

While an example manner of implementing the CAB system 200 has been illustrated in FIG. 2, one or more of the elements, processes and/or devices illustrated in FIG. 2 may be combined, divided, re-arranged, omitted, eliminated and/or implemented in any other way. Further, the example CAB server 105, the example CAB client 110, the example CAB XDMS 130, the example core network 205, the example CAB AB XDMS 210, the example CAB PCC XDMS 215, the example CAB user preference XDMS 220, the example client messaging unit 225, the example user request formatter 230, the example user request unit 235, the example server messaging unit 240, the example service request parser 245, the example service request processor 250 and/or, more generally, the example CAB system 200 of FIG. 2 may be implemented by hardware, software, firmware and/or any combination of hardware, software and/or firmware. Thus, for example, any of the example CAB server 105, the example CAB client 110, the example CAB XDMS 130, the example core network 205, the example CAB AB XDMS 210, the example CAB PCC XDMS 215, the example CAB user preference XDMS 220, the example client messaging unit 225, the example user request formatter 230, the example user request unit 235, the example server messaging unit 240, the example service request parser 245, the example service request processor 250 and/or, more generally, the example CAB system 200 could be implemented by one or more circuit(s), programmable processor(s), application specific integrated circuit(s) (ASIC(s)), programmable logic device(s) (PLD(s)) and/or field programmable logic device(s) (FPLD(s)), etc. In some instances, at least one of the example CAB system 200, the example CAB server 105, the example CAB client 110, the example CAB XDMS 130, the example core network 205, the example CAB AB XDMS 210, the example CAB PCC XDMS 215, the example CAB user preference XDMS 220, the example client messaging unit 225, the example user request formatter 230, the example user request unit 235, the example server messaging unit 240, the example service request parser 245 and/or the example service request processor 250 include a tangible medium such as a memory, digital versatile disk (DVD), compact disk (CD), etc., storing such software and/or firmware. Further still, the example CAB system 200 of FIG. 2 may include one or more elements, processes and/or devices in addition to, or instead of, those illustrated in FIG. 2, and/or may include more than one of any or all of the illustrated elements, processes and devices.

An example message sequence diagram 300 illustrating example messaging to exchange CAB service requests and responses in the example CAB systems 100 or 200 of FIGS. 1 and 2, respectively, is illustrated in FIG. 3A. In particular, the message sequence diagram 300 illustrates the messaging exchanged between the CAB client 110 and the CAB XDMS 130, as well as the messaging exchanged between the CAB server 105 and the CAB XDMS 130, to exchange CAB service requests and responses between the CAB client 110 and the CAB server 105. The CAB service requests and responses can correspond to any CAB service implemented by the CAB server 105, such as the contact share service, the contact subscription service the import non-CAB address book service, among others.

Turning to FIG. 3A, and with reference to FIG. 2, the message sequence diagram 300 begins with the CAB client 110 sending a store user request message 305 to the CAB XDMS 130 to store a CAB service request formatted according to the example CAB service handler application usage illustrated in FIGS. 4A-D. For example, the store user request message 305 may correspond to an XCAP HTTP PUT message sent by the client messaging unit 225 of the CAB client 110 and containing the formatted CAB service request. Then, in response to receiving the store user request message 305, the CAB XDMS 130 returns an acknowledgment (ACK) message 310, such as an HTTP 200/OK message, to the CAB client 110.

Next, the CAB server 105 utilizes a retrieve service request message 315 to retrieve the CAB service request stored by the CAB client 105 at the CAB XDMS 130 via the store user request message 305. For example, the retrieve service request message 315 can correspond to a SIP SUBSCRIBE message subscribing the CAB server 105 to be notified of changes in the data stored on the CAB XDMS 130, with the SIP SUBSCRIBE message having been sent by the server messaging unit 240 of the CAB server 105 to the CAB XDMS 130 sometime before the CAB service request was stored at the CAB XDMS 130. In another example, the retrieve service request message 315 can correspond to an XCAP HTTP GET message sent by the server messaging unit 240 of the CAB server 105 to the CAB XDMS 130 to retrieve the stored CAB service request. Then, the CAB server 105 receives a response message 320 containing the CAB service request from the CAB XDMS 130. For example, the response message 320 can correspond to a SIP NOTIFY message containing the CAB service request (e.g., such as when the retrieve service request message 315 corresponds to a SIP SUBSCRIBE message) or an HTTP 200/OK message accompanied by the CAB service request (e.g., such as when the retrieve service request message 315 corresponds to an XCAP HTTP GET message).

Next, the CAB server 105 invokes the appropriate CAB service(s) indicated in the request (e.g., such as the contact share service, the contact subscription service the import non-CAB address book service, etc.) to processes the retrieved CAB service request with the assistance of one or more of the service request processor units 250. The processing of the CAB service request is indicated by the directed arrow 325. After processing completes, the CAB server 105 sends a store response status message 330 to the CAB XDMS 130 to store an appropriate response to the processed CAB service request, with the response formatted according to the example CAB service handler application usage illustrated in FIGS. 4A-D. For example, the store response status message 330 may correspond to an XCAP HTTP PUT message sent by the server messaging unit 240 of the CAB server 105 and containing the formatted response. Then, in response to receiving the store response status message 330, the CAB XDMS 130 returns an ACK message 335, such as an HTTP 200/OK message, to the CAB server 105.

Next, the CAB client 110 utilizes a retrieve response status message 340 to retrieve the CAB service response stored by the CAB server 110 at the CAB XDMS 130 via the store response status message 330. For example, the retrieve response status message 340 can correspond to a SIP SUBSCRIBE message subscribing the CAB client 110 to be notified of changes in the data stored on the CAB XDMS 130, with the SIP SUBSCRIBE message having been sent by the client messaging unit 225 of the CAB client 110 to the CAB XDMS 130 sometime before the CAB service response was stored at the CAB XDMS 130. In another example, the retrieve response status message 340 can correspond to an XCAP HTTP GET message sent by the client messaging unit 225 of the CAB client 110 to the CAB XDMS 130 to retrieve the stored CAB service response. Then, the CAB client 110 receives a response message 345 containing the CAB service response from the CAB XDMS 130. For example, the response message 345 can correspond to a SIP NOTIFY message containing the CAB service response (e.g., such as when the retrieve response status message 340 corresponds to a SIP SUBSCRIBE message) or an HTTP 200/OK message accompanied by the CAB service response (e.g., such as when the retrieve response status message 340 corresponds to an XCAP HTTP GET message). The example message sequence diagram 300 then ends. Although subscription and notification are illustrated in FIG. 3A as being implemented via SIP SUBSCRIBE and NOTIFY messaging, other subscribe/notify paradigms could be used to exchange CAB service requests and responses in the example CAB systems 100 or 200 of FIGS. 1 and 2 (e.g., such as XDCP/Push implemented over the XDM-NON_SIP illustrated in FIG. 2, among others).

Another example message sequence diagram 350 illustrating example messaging to exchange CAB user requests and responses in the example CAB systems 100 or 200 of FIGS. 1 and 2, respectively, is illustrated in FIG. 3B. In particular, the message sequence diagram 350 illustrates the messaging exchanged between the CAB client 110 and the CAB XDMS 130, the transformations occurring at the CAB XDMS 120, acting as a proxy. In addition, the messaging (e.g., CAB server targeted requests) exchanged between the CAB server 105 and the CAB XDMS 130, to provide or support the associated CAB user requests to initiate, for example, the contact share service, the contact subscription service, the import non-CAB address book service, etc., is also illustrated

Turning to FIG. 3B, and with reference to FIG. 2, the message sequence diagram 350 begins with a CAB server initiating a subscribe request 352 to the CAB XDMS 130 in order to receive notifications regarding CAB server requests on behalf of a CAB client 110. Next, the CAB client 110 issues a store user request message 355 to the CAB XDMS 130 to store a CAB service request formatted according to the example CAB service handler application usage illustrated in FIGS. 4A-D. For example, the store user request message 355 may correspond to an XCAP HTTP PUT message sent by the client messaging unit 225 of the CAB client 110 and containing the formatted CAB service user request. Then, in response to receiving the store user request message 355, the CAB XDMS 130 transforms the CAB service user request (e.g., such as a contact share user request) into one or more CAB server request primitives as shown by arrow 365. This may result in the CAB XDMS 130 generating a specific CAB Server Request document as shown by arrow 366. The CAB XDMS 130 then returns an acknowledgment (ACK) message 360, such as an HTTP 200/OK message, to the CAB client 110.

Next, the CAB XDMS 130 as a result of the apriori subscription from CAB server 105, sends a series of one or more notification messages (368-a/b) toward the CAB server. These notification messages contain the suitably transformed CAB server requests on behalf of a client CAB user request. CAB server 105 then processes each request (and may issue an ACK message—not shown) toward the CAB XDMS 130. As a result of processing each discrete CAB service primitive in order to achieve a particular CAB service user request (represented by the arrows 375-a/b), CAB server 105 issues one or more CAB server response(s) as shown by arrows 380-a/b.

As a result of these responses, the CAB XDMS 130 processes these results on behalf of the CAB server 105 and the CAB client 110. Processing by CAB XDMS 130 may include, for example, transforming CAB server response codes into corresponding CAB service user request/response codes. Processing may also include storing these codes (as shown by arrow 367) or in the scenario whereby a CAB server request primitive has failed, re-initiating the notification process (as shown by arrows 368-a/b-380-a/b inclusive) to the CAB server 105, as a retry mechanism.

Next, the CAB XDMS 130, after resolving a given CAB service user request, permits a CAB client 110 to either retrieve (as shown by arrow 390) or receive notification (not shown in figure) regarding the status or result of CAB service user requests (e.g., assuming a CAB client 110 has subscribed to be notified of these changes either directly or indirectly). The CAB XDMS 130 provides one or more CAB service user requests (arrow 395) in response to the request by CAB client 110.

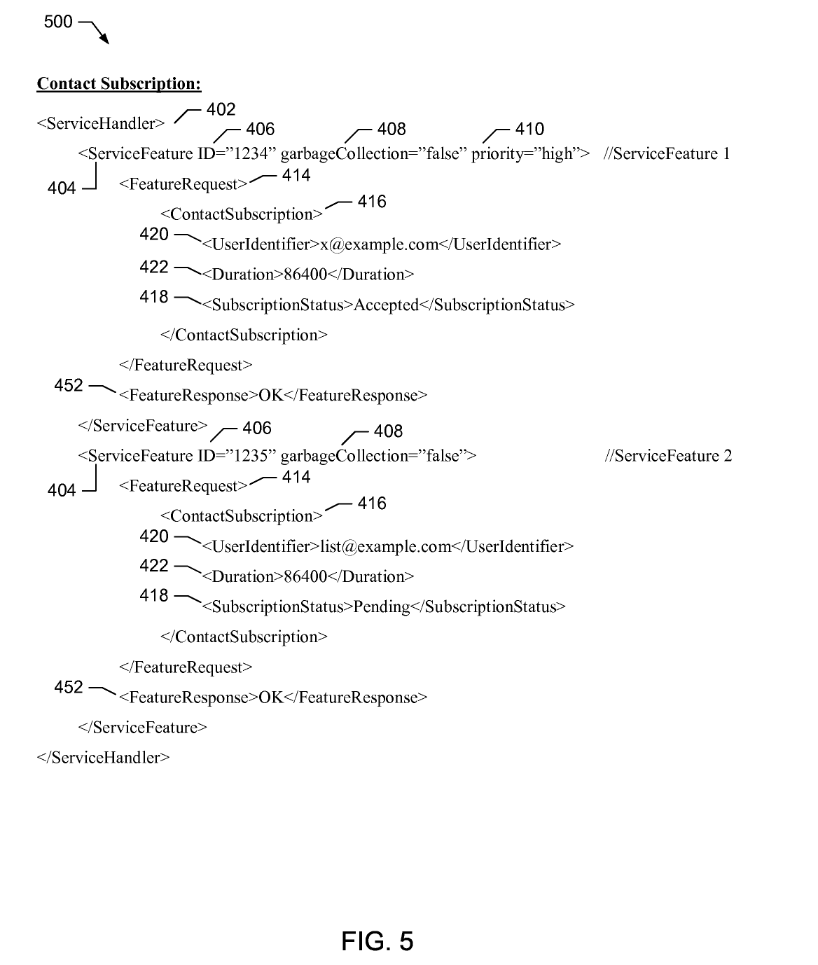

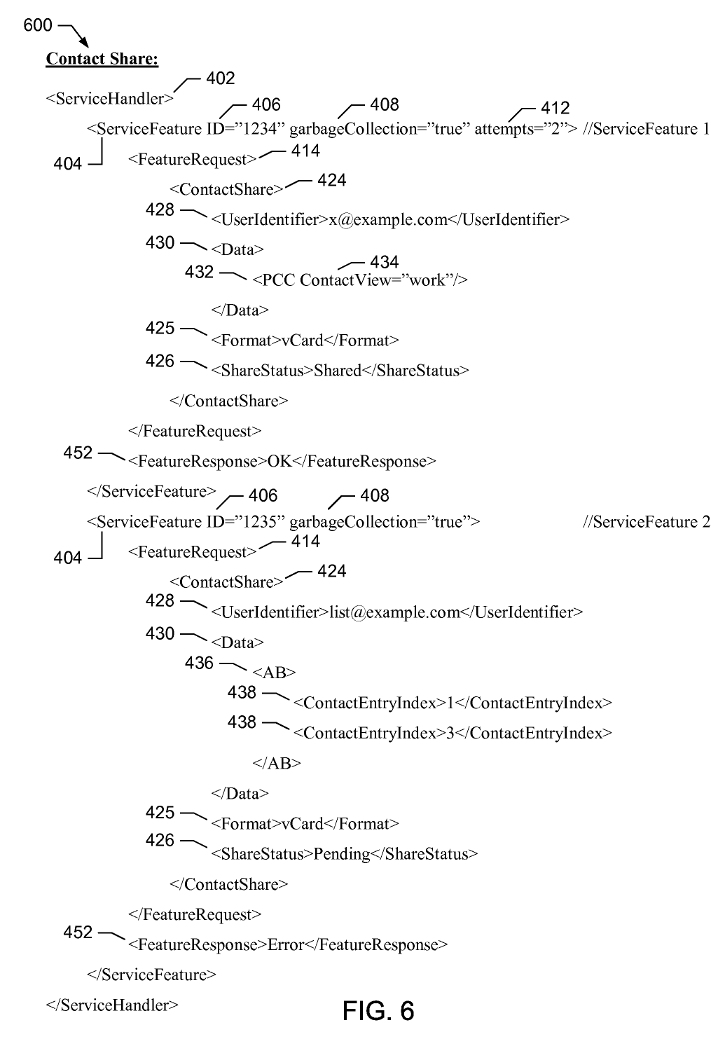

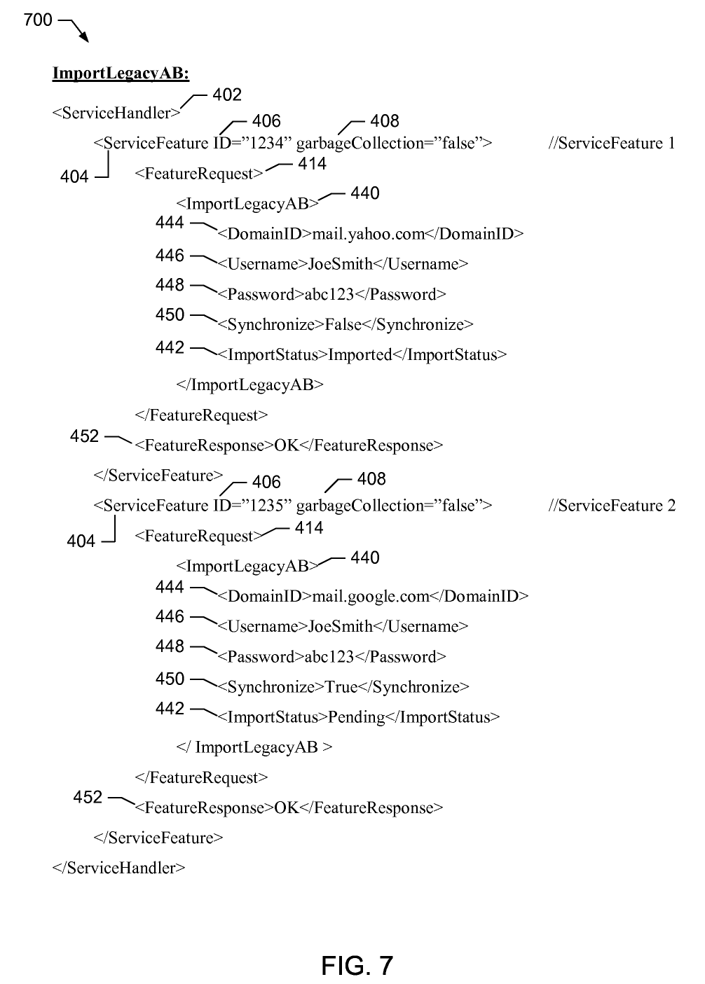

An example CAB service handler XDM application usage 400 specifying the syntax/schema for formatting CAB service requests and associated responses for storage in one or more XML documents at the CAB XDMS 130 is illustrated in FIGS. 4A-D. The structure of the elements and attributes defined in the schema represented by the table of FIGS. 4A-4D is only an example of the parameters that may be defined to support an application usage for service requests and responses; the actual structure or schema may be different for different example implementations. In the following, the example CAB service handler application usage 400 is described in the context of the example CAB service handler XML data structures illustrated in FIGS. 5-7. In particular, an example contact subscription service handler data structure 500 is illustrated in FIG. 5, an example contact share service handler data structure 600 is illustrated in FIG. 6, and an example import non-CAB address book service handler data structure 700 is illustrated in FIG. 7.

The example CAB service handler application usage 400 begins with a ServiceHandler element 402 corresponding to the root node of the application usage and representing a container for handling service feature requests and associated responses on a per user basis. Next, each instance of a CAB service request is indicated using a ServiceFeature element 404. A complete CAB service handler XML data structure can include requests for multiple CAB services. The ServiceFeature element 404 is characterized by an ID attribute 406, a GarbageCollection attribute 408, a Priority attribute 410 and an Attempts attribute 412. The ID attribute 406 is an integer value representing a unique ID assigned to a service feature request that is used to correlate requests and responses. The ID attribute 406 is computed on a per user and a per device basis to distinguish CAB service requests from multiple user requests and their respective devices, and therefore should be unique. The GarbageCollection attribute 408 is a boolean value indicating whether the corresponding CAB service request and associated response data stored on the CAB XDMS 130 is to be cleaned-up after processing completes. The Priority attribute 410 indicates a priority of the corresponding CAB service request (e.g., such as high, normal, low, etc.) relative to other service requests. The Attempts attribute 412 is an integer specifying the number of retry attempts the CAB server 105 is to perform to process the CAB service request before indicating the processing of the request has failed.

Examples of using the ServiceHandler element 402, the ServiceFeature element 404, the ID attribute 406, the GarbageCollection attribute 408, the Priority attribute 410 and the Attempts attribute 412 in the context of formatting contact subscription service requests/responses, contact share service requests/responses and import non-CAB address book service requests/responses are shown in FIGS. 5, 6 and 7 respectively.

The example CAB service handler application usage 400 further includes a FeatureRequest element 414 to indicate a group of service feature request data corresponding to a particular CAB service request. The particular group of service feature request data included in a particular CAB service request depends on the type of the CAB service request. For example, a service request corresponding to the contact subscription service is indicated using a ContactSubscription element 416. The group of service feature request data following the ContactSubscription element 416 includes a SubscriptionStatus element 418, a UserIdentifier element 420 and a Duration element 422. The SubscriptionStatus element 418 is a response that indicates the status of the subscription request, such as whether the request is pending authorization or has been accepted by the subscribed user. This field is generally managed by the network (e.g., such as by the CAB server 105) and the user (e.g., such as the CAB client 110) can only view the value of this field. Further, the value of this field may be utilized to keep track of a list of other users for which subscription is pending for the particular CAB user. This status information may also be displayed in the corresponding contact entry of the user's address book at the client device. For example, a text or icon similar to “contact subscription pending” may be displayed next to the contact entry to which the CAB user has requested to be subscribed. The UserIdentifier element 420 represents the uniform resource identifier (URI) for the destination user to which the source user wishes to subscribe using the CAB subscription service request. For example, the URI can correspond to an XCAP user identifier (XUI) of the destination user or a list of URIs representing multiple users, or both. The Duration element 422 represents the duration of the subscription period, such as an integer representing the duration in seconds.

An example of using the FeatureRequest element 414, the ContactSubscription element 416, the SubscriptionStatus element 418, the UserIdentifier element 420 and the Duration element 422 in the context of formatting contact subscription service requests/responses is shown in FIG. 5.

As another example, a service request corresponding to the contact share service is indicated using a ContactShare element 424. The group of service feature request data following the ContactShare element 424 includes a Format element 425, a ShareStatus element 426, a UserIdentifier element 428, a Data element 430, a PCC element 432 characterized by a ContactView attribute 434, an AB element 436 and a ContactEntryIndex element 438. The Format element 425 indicates the format of the data to be shared. Multiple data formats can be supported, such as CAB format, vCard, hCard, etc., with the default value being vCard in the illustrated example. The ShareStatus element 426 is a response that indicates the status of the share request, such as whether the share request is pending or sent or accepted by the recipient user. This field is generally managed by the network (e.g., such as by the CAB server 105) and the user (e.g., such as the CAB client 110) can only view the value of this field. Further, the value of this field may be utilized to keep track of a list of other users for which share request is pending for the particular CAB user. This status information may also be displayed in the corresponding contact entry of the user's address book at the client device. For example, a text or icon similar to “contact share pending” may be displayed next to the contact entry for which the CAB user has requested to share data. The UserIdentifier element 428 represents the URI for the destination user to which the source user wishes to share CAB data. For example, the URI can correspond to an XUI of the destination user or a list of URIs, or both. The Data element 430 is used to demarcate a particular type of data to be shared, such as the user's personal contact card (PCC), a contact entry in the user's address book (AB), or both. The PCC element 432 indicates that PCC content is to be shared, and is characterized by the ContactView attribute 434 specifying which contact view within the PCC is to be shared. The AB element 436 indicates that AB content is to be shared. The ContactEntryIndex element 438 represents the URI of a contact entry in the address book to be shared. Multiple contact entries are allowed in a single CAB contact share service request.

An example of using the FeatureRequest element 414, the ContactShare element 424, the Format element 425, the ShareStatus element 426, the UserIdentifier element 428, the Data element 430, the PCC element 432, the ContactView attribute 434, the AB element 436 and the ContactEntryIndex element 438 in the context of formatting contact share service requests/responses is shown in FIG. 6.

As yet another example, a service request corresponding to the import non-CAB address book service is indicated using an ImportLegacyAB element 440. The group of service feature request data following the ImportLegacyAB element 440 includes an ImportStatus element 442, a DomainID element 444, a Username element 446, a Password element 448 and a Synchronize element 450. The ImportStatus element 442 indicates the status of the import non-CAB address book request, such as whether the request is pending (e.g., such as when the CAB server 105 is in the process of importing the requested data and the import operation is still in progress or requires further user actions to validate the data that is being imported) or accepted (e.g., such as when importing of the data that has been requested by the user to be imported has been completed). The DomainID element 444 represents the domain name of the legacy or non-CAB system from which the non-CAB address book is to be imported. The Username element 446 represents the user's username for accessing the legacy or non-CAB system. The Password element 448 represents the user's password for accessing the legacy or non-CAB system. The Synchronize element 450 indicates whether the import request should remain synchronized or, in other words, whether the user's CAB address book should be kept up-to-date with any subsequent changes made to the imported non-CAB address book that has been requested to be imported. The default value is false to indicate that the operation to import non-CAB data is done only once and it is not periodic in nature.

An example of using the FeatureRequest element 414, the ImportLegacyAB element 440, the ImportStatus element 442, the DomainID element 444, the Username element 446, the Password element 448 and the Synchronize element 450 in the context of formatting import non-CAB address book service requests/responses is shown in FIG. 7.

In at least some example implementations, a user service request can be deleted from the CAB service handler XML data structure to indicate that the request is not to be processed for the user (e.g., such as when the user is no longer interested in the CAB feature corresponding to the request). For example, if a user would like to unsubscribe from a contact subscription directed to another user, deletion of the FeatureRequest element 414 and associated group of service feature request data (e.g., the ContactSubscription element 416 and so on) corresponding to this contact subscription from the CAB service handler XML data structure indicates that the user would like to unsubscribe from the contact subscription. Upon noticing this deletion, the CAB server 105 would stop contact subscription processing and perform any other appropriate operations to unsubscribe the user from the contact subscription. Similarly, deletion of the FeatureRequest element 414 and associated group of service feature request data corresponding to a contact share service request (e.g., the ContactShare element 424 and so on) or an import non-CAB address book service request (e.g., the ImportLegacyAB element 440 and so on) from the CAB service handler XML data structure would indicate to the CAB server 105 that performance of the respective service is no longer desired and can be halted.

Further, modification of data related to any of the existing CAB user service requests in the application usage instance document by the CAB client 110 may be treated as a new request by the CAB server 105.

The example CAB service handler application usage 400 further includes a FeatureResponse element 452 to provide service feature response data, which can include an error message or response status for the corresponding CAB service request. For example, the response status can be an ‘OK’ code to indicate that the request has been successfully processed by the CAB server 105. As another example, the response status can be a ‘Processing Error’ code to indicate that the request could not be understood by the server. These and/or other response codes can be specified to accommodate the reporting of various types of status. For example, error codes reported by the FeatureResponse element 452 could be modeled around the Internet Engineering Task Force (IETF) request for comment (RFC) 2616 that defines status codes for the HTTP protocol. IETF RFC 2616, which is publicly available, is hereby incorporated by reference in its entirety. Examples of using the FeatureResponse element 452 in the context of formatting contact subscription service requests/responses, contact share service requests/responses and import non-CAB address book service requests/responses are shown in FIGS. 5, 6 and 7 respectively.

Although the example CAB service handler application usage 400 is described in the context of formatting service requests/responses for the CAB contact subscription service, the CAB contact share service and the CAB import of non-CAB address book service, the CAB service handler application usage 400 could be readily adapted to support any service request requiring usage of an XDMS as a proxy for exchanging messages between a client and an application server.

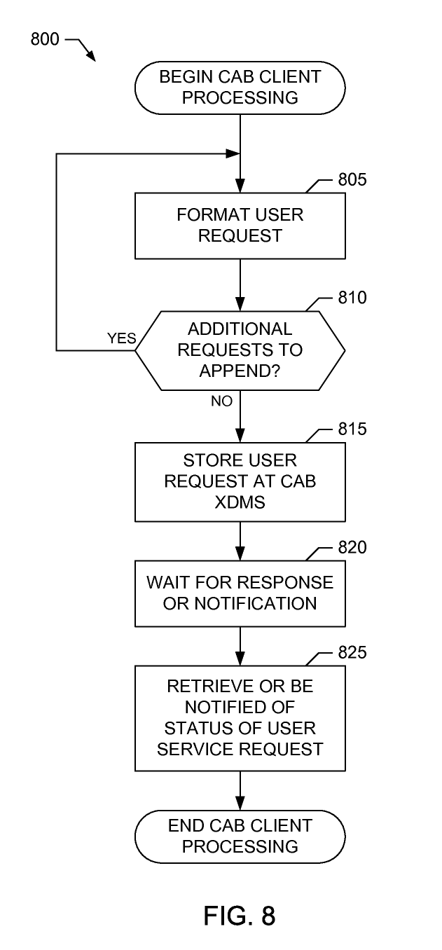

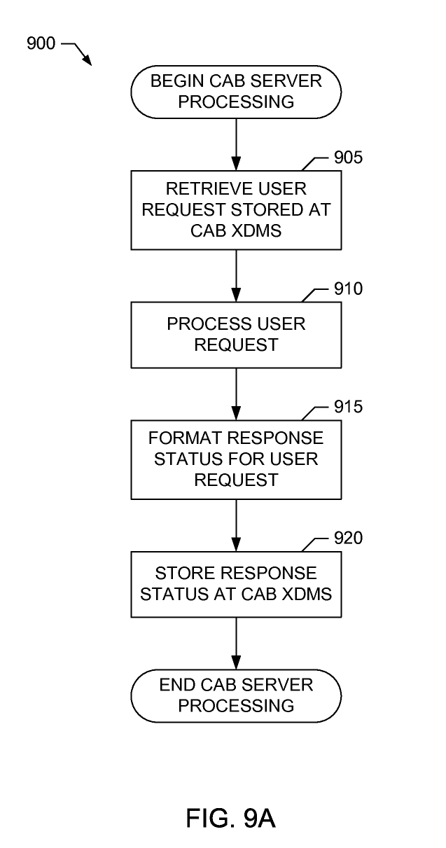

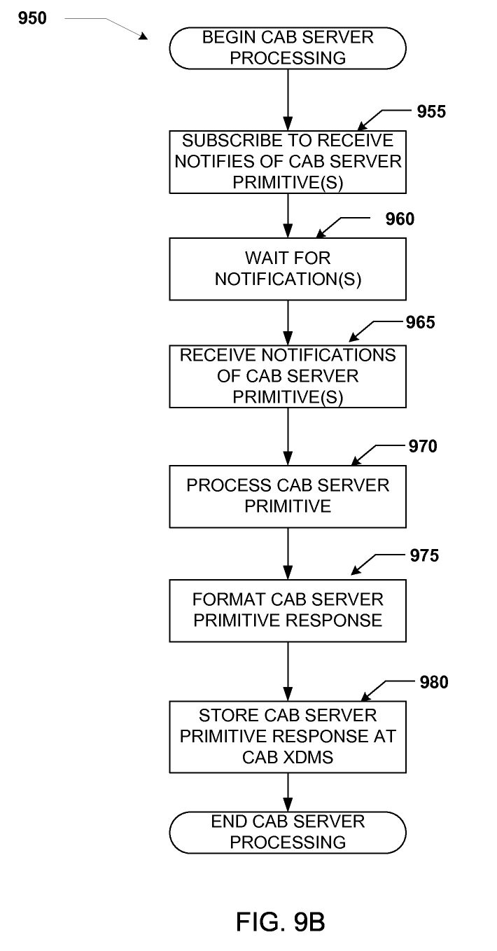

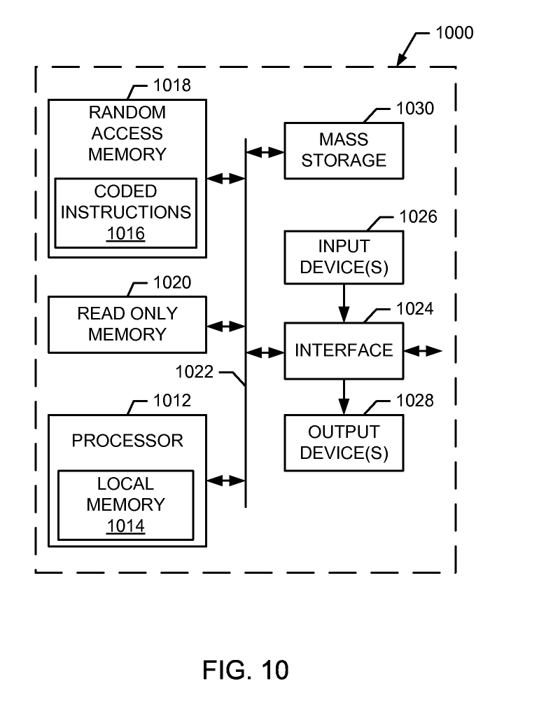

Flowcharts representative of example processes that may be executed to implement any or all of the example CAB system 100, the example CAB system 200, the example CAB server 105, the example CAB client 110, the example CAB XDMS 130, the example core network 205, the example CAB AB XDMS 210, the example CAB PCC XDMS 215, the example CAB user preference XDMS 220, the example client messaging unit 225, the example user request formatter 230, the example user request unit 235, the example server messaging unit 240, the example service request parser 245 and/or the example service request processor 250 are shown in FIGS. 8 and 9A-B. In these examples, the process represented by each flowchart may be implemented by one or more programs comprising machine readable instructions for execution by: (a) a processor, such as the processor 1012 shown in the example computer 1000 discussed below in connection with FIG. 10, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 1012, but the entire program or programs and/or portions thereof could alternatively be executed by a device other than the processor 1012 and/or embodied in firmware or dedicated hardware (e.g., implemented by an application specific integrated circuit (ASIC), a programmable logic device (PLD), a field programmable logic device (FPLD), discrete logic, etc.).

For example, any or all of the example CAB system 100, the example CAB system 200, the example CAB server 105, the example CAB client 110, the example CAB XDMS 130, the example core network 205, the example CAB AB XDMS 210, the example CAB PCC XDMS 215, the example CAB user preference XDMS 220, the example client messaging unit 225, the example user request formatter 230, the example user request unit 235, the example server messaging unit 240, the example service request parser 245 and/or the example service request processor 250 could be implemented by any combination of software, hardware, and/or firmware. Also, some or all of the processes represented by the flowcharts of FIGS. 8 and 9A-B may be implemented manually. Further, although the example processes are described with reference to the flowcharts illustrated in FIGS. 8 and 9A-B, many other techniques for implementing the example methods and apparatus described herein may alternatively be used. For example, with reference to the flowcharts illustrated in FIGS. 8 and 9A-B, the order of execution of the blocks may be changed, and/or some of the blocks described may be changed, eliminated, combined and/or subdivided into multiple blocks.

An example process 800 that may be executed to implement functionality in the CAB client 110 for exchanging CAB service request messages and responses with the CAB server 105 via the CAB XDMS 130 acting as a proxy server is illustrated in FIG. 8. The example process 800 may be executed, for example, whenever the CAB client 110 is to send a CAB service request intended to invoke a corresponding CAB service provided by the CAB server 105. Furthermore, in at least some example implementations, multiple instances of the example process 800 may be executing (e.g., in parallel) at any given time, with each instance corresponding to a different set of service requests.

With reference to FIGS. 2, 3A-B and 4A-D, the process 800 of FIG. 8 begins execution at block 805 at which the example CAB client 110 formats a CAB user service request intended to invoke a corresponding CAB service provided by the CAB server 105. For example, at block 805 the user request formatter 230 of the CAB client 110 can format the CAB user request according to the CAB service handler application usage 400 illustrated in FIGS. 4A-D. Next, control proceeds to block 810 at which the CAB client 110 determines whether there are additional individual user service requests to append to the overall service request to be sent by the CAB client 110. As illustrated in the example XML data structures of FIGS. 5-7, multiple CAB service requests can be included in a complete CAB service request instantiation formatted by the user request formatter 230 for transmission by the CAB client 110 to the CAB XDMS 130. Accordingly, if there are additional requests to append (block 810), control returns to block 805 at which the user request formatter 230 of the CAB client 110 formats the next user request.

However, if there are no additional requests to append (block 810), control proceeds to block 815 at which the CAB client 110 sends the store user request message 305 to the CAB XDMS 130 to store the formatted CAB service user request for subsequent retrieval by the CAB server 105. For example, at block 815 the client messaging unit 225 of the CAB client 110 can send an XCAP HTTP PUT message containing the formatted CAB service request as the store user request message 305. Next, control proceeds to block 820 at which the CAB client waits until a response associated with the CAB user service request stored at the CAB XDMS 130 at block 815 is ready for retrieval or until a notification containing the response is received. For example, the CAB client 110 can implement any appropriate waiting mechanism, such as any or all of a polling mechanism, an interrupt mechanism, a timer mechanism, etc., to implement the waiting period at block 820. Furthermore, the CAB client 110 may be configured to perform other processing (e.g., such as executing other instances of the example process 800) during the waiting period at block 820.

After waiting for the response at block 820, control proceeds to block 825 at which the CAB client 110 utilizes a retrieve response status message 340 to retrieve the response associated with the CAB user service request stored at the CAB XDMS 130 at block 815. For example, at block 825 the client messaging unit 225 of the CAB client 110 can receive a SIP NOTIFY message containing the appropriate response triggered due to a previous SIP SUBSCRIBE message implementing the retrieve response status message 340. In another example, the retrieve response status message 340 can correspond to an XCAP HTTP GET message sent by the client messaging unit 225 of the CAB client 110 to the CAB XDMS 130 to retrieve the appropriate stored response. The response retrieved from the CAB XDMS 130 can include, for example, any of the response information specified in the CAB service handler application usage 400 for the CAB service request stored at the CAB XDMS 130 at block 815. Then, after processing at block 825 completes, execution of the process 800 ends.

An example process 900 that may be executed to implement functionality in the CAB server 105 for exchanging CAB service request messages and responses with the CAB client 110 via the CAB XDMS 130 acting as a proxy server is illustrated in FIG. 9A. The example process 900 may be executed, for example, whenever the CAB client 110 is to retrieve or be notified of a CAB service request stored at the CAB XDMS 130 by the CAB server 105. Furthermore, in at least some example implementations, multiple instances of the example process 900 may be executing (e.g., in parallel) at any given time, with each instance corresponding to a different set of service requests.

With reference to FIGS. 2, 3A and 4A-D, the process 900 of FIG. 9A begins execution at block 905 at which the CAB server 105 utilizes the retrieve service request message 315 to retrieve one or more CAB service requests stored by the CAB client 105 at the CAB XDMS 130. For example, at block 905 the server messaging unit 240 of the CAB server 105 can receive SIP NOTIFY message containing one or more server requests/primitives triggered due to a previous SIP SUBSCRIBE message implementing the retrieve service request message 315. In another example, the retrieve service request message 315 can correspond to an XCAP HTTP GET message sent by the server messaging unit 240 of the CAB server 105 to the CAB XDMS 130 to retrieve the stored CAB server request(s)/primitive(s).

Next, at block 910 the CAB server 105 invokes the appropriate CAB service(s) (e.g., such as the contact share service, the contact subscription service the import non-CAB address book service, etc.) indicated in the CAB service request(s) retrieved at block 905 to process the request. For example, at block 910 the service request parser 245 of the CAB server 105 may parse a request retrieved at block 905 according to the CAB service handler application usage 400 to determine how the service request processor 250 is to process the request. After processing of the retrieved request(s) completes at block 910, control proceeds to block 915 at which the CAB server 105 formats a response to the processed request to be stored at the CAB XDMS 130 for subsequent retrieval by the CAB client 110. For example, at block 915 the service request processor 250 of the CAB server 105 formats the response according to the CAB service handler application usage 400.

Next, control proceeds to block 920 at which the CAB server 105 sends the store response status message 330 to the CAB XDMS 130 to store the formatted response associated with the CAB service request retrieved at block 905. The stored response will be retrieved from the CAB XDMS 130 by the CAB client 110 responsible for the CAB service request retrieved at block 905. For example, at block 920 the server messaging unit 240 of the CAB server 105 can send an XCAP HTTP PUT message containing the formatted response as the store response status message 330. After the response is stored at block 920, execution of the process 900 ends.

An example process 950 that may be executed to implement functionality in the CAB server 105 for exchanging CAB service request messages and responses with the CAB client 110 via the CAB XDMS 130 acting as a proxy server is illustrated in FIG. 9B. The example process 950 may be executed, for example, whenever the CAB client 110 is to retrieve or be notified of a CAB service request stored at the CAB XDMS 130 by the CAB server 105. Furthermore, in at least some example implementations, multiple instances of the example process 950 may be executing (e.g., in parallel) at any given time, with each instance corresponding to a different set of service requests.

With reference to FIGS. 2, 3B and 4A-D, the process 950 of FIG. 9B begins execution at block 955 at which the CAB server 105 subscribes to CAB XDMS 130 to receive notification of CAB server primitive requests. CAB server 105 then moves to block 960 in order to wait for a CAB server primitive notification request to arrive. At block 965, CAB server 105 receives a notification (e.g., such as a SIP NOTIFY message) corresponding with a CAB server primitive. At block 970, the CAB server processes this primitive from the CAB XDMS 130, which generates a corresponding result.

Next, at block 975 the CAB server 105 formats the CAB server primitive response. This response is in the format native to the server response (unlike that shown in the example process 900 if FIG. 9A). Proceeding to block 980, the CAB server 105 stores the CAB server primitive response (or result) back to CAB XDMS 130. After the response is stored at block 980, execution of the process 950 ends.

FIG. 10 is a block diagram of an example computer 1000 capable of implementing the apparatus and methods disclosed herein. The computer 1000 can be, for example, a server, a personal computer, a personal digital assistant (PDA), an Internet appliance, a DVD player, a CD player, a digital video recorder, a personal video recorder, a set top box, a smartphone, or any other type of computing device.

The system 1000 of the instant example includes a processor 1012 such as a general purpose programmable processor. The processor 1012 includes a local memory 1014, and executes coded instructions 1016 present in the local memory 1014 and/or in another memory device. The processor 1012 may execute, among other things, machine readable instructions to implement the processes represented in FIGS. 8 and 9A-B. The processor 1012 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1012 is in communication with a main memory including a volatile memory 1018 and a non-volatile memory 1020 via a bus 1022. The volatile memory 1018 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1020 may be implemented by flash memory and/or any other desired type of memory device. Access to the main memory 1018, 1020 is typically controlled by a memory controller (not shown).

The computer 1000 also includes an interface circuit 1024. The interface circuit 1024 may be implemented by any type of interface standard, such as an Ethernet interface, a universal serial bus (USB), and/or a third generation input/output (3GIO) interface.

One or more input devices 1026 are connected to the interface circuit 1024. The input device(s) 1026 permit a user to enter data and commands into the processor 1012. The input device(s) can be implemented by, for example, a keyboard, a mouse, a touchscreen, a track-pad, a trackball, an isopoint and/or a voice recognition system.

One or more output devices 1028 are also connected to the interface circuit 1024. The output devices 1028 can be implemented, for example, by display devices (e.g., a liquid crystal display, a cathode ray tube display (CRT)), by a printer and/or by speakers. The interface circuit 1024, thus, typically includes a graphics driver card.

The interface circuit 1024 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1000 also includes one or more mass storage devices 1030 for storing software and data. Examples of such mass storage devices 1030 include floppy disk drives, hard drive disks, compact disk drives and digital versatile disk (DVD) drives.

As an alternative to implementing the methods and/or apparatus described herein in a system such as the device of FIG. 10, the methods and or apparatus described herein may be embedded in a structure such as a processor and/or an ASIC (application specific integrated circuit).

From the foregoing, example methods and apparatus to exchange CAB service requests and response via a network repository acting as a proxy are disclosed. As a further example, the example methods and apparatus described herein can be supported in the OMA CAB specifications as follows.

Structure: In this example, the CAB service handler XDM application usage 400 defines the semantics of the CAB service request and response data stored in the CAB XDMS 130.

Application Unique ID (AUID): In this example, the AUID is to be “org.openmobilealliance.cab-service-handler.”

XML Schema: In this example, a “cab-service-handler” XML document is to be composed according to the CAB service handler XDM application usage 400.

Default Namespace: In this example, the default namespace used in expanding URIs is to be “urn:oma:xml:cab:service-handler.”

Multipurpose Internet Mail Extension (MIME) Type: In this example, the MIME type for the CAB requests document is to be “application/vnd.oma.cab-service-handler+xml.”

Validation Constraints: In this example, the validation constraints are subject to the CAB service handler XDM application usage 400, and may contain other constraints.

Data Semantics: The semantics for this application usage are defined in the Description column of the table shown in FIGS. 4A-D. In this example, it is possible (on commitment of a service feature) to require the CAB XDMS 130 to automatically subscribe (e.g., based on configuration and/or policy) on behalf of the associated proxy-client (e.g., the CAB client 110), to receive the outcome of the service feature. In this way, the service client (e.g., the CAB client 110) may receive automatic notification, when the service under proxy (e.g., the CAB server 105) completes the feature (e.g., it runs to a successful conclusion or fails with an associated error response).

Naming Conventions: The name of the CAB service handler document is to be “Service-Handler.”

Global Documents: In this example, no global documents are envisioned for the CAB service handler XDM application usage 400.

Resource Interdependencies: In this example, the CAB service handler XDM application usage 400 may define additional resource interdependencies.

Authorization Policies: In this example, the authorization policies are to be based on the conventional IETF policy that is commonly used in XDM, with possible extensions as needed in the particular implementations. For example, the SubscriptionStatus, ShareStatus, and ImportStatus fields can be set to read-only for the CAB client 110 while allowing read-write privileges for the CAB server 105.

Search Capabilities: In this example, the data in this application usage can be made accessible to search queries based on XQuery which is already supported in the XDM enabler. The schema of this application usage may need to be configured at the client making the search requests.

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
storing, at a network repository of a converged address book (CAB) service, a request identifying a CAB service feature; and
obtaining, from said network repository, a response associated with said request, said request and said response being stored in a document conforming to a CAB service handler application usage.

2. A method as defined in claim 1 wherein the document includes a unique identifier assigned to said request to associate said request with said response.

3. A method as defined in claim 1 wherein the CAB service feature corresponds to a CAB contact share function, and the method further comprises:
including in said request, a recipient or list of recipients with which contact data is to be shared; and
including in said request, an indication of the contact data to be shared.

4. A method as defined in claim 3 wherein the indication of the contact data to be shared specifies at least one of personal contact card data or a reference to address book contact entry data.

5. A method as defined in claim 3 wherein the method further comprises:
including in said request, a status of delivering the contact data associated with said request to one or more recipients, the status to be set to read-only for a CAB client making the request, the status to be updateable by a CAB server.

6. A method as defined in claim 1 wherein the CAB service feature corresponds to a CAB import address book function, and the method further comprises:
including in said request, a domain name of a non-CAB system from which non-CAB address book data is to be imported; and
including in said request, a credential for accessing the non-CAB system.

7. A method as defined in claim 6 wherein the credential is a username and a password for accessing the non-CAB system.

8. A method as defined in claim 6 further comprising:
including in said request, an indication of whether the non-CAB address book data is to be updated periodically or whether said request is a one-time request.

9. A method as defined in claim 1 wherein obtaining said response from the network repository comprises at least one of (1) using a subscription procedure to cause a notification to be sent to indicate when to retrieve said response from the network repository, or (2) polling for said response using an extensible markup language (XML) configuration access protocol (XCAP) message.

10. A method as defined in claim 1 wherein said response includes a status code which indicates whether at least one of (1) said request has been successfully processed by a CAB server, or (2) a processing error has occurred.

11. A method as defined in claim 1 further comprising deleting said request from the document after said request has been processed.

12. A method as defined in claim 1 wherein the network repository is implemented by an XML document management server.

13. A tangible article of manufacture storing machine readable instructions which, when executed, cause a machine to implement the method defined in claim 1.

14-23. (canceled)

24. A method comprising:
retrieving, from a network repository of a converged address book (CAB) service, a request identifying a CAB service feature; and
storing, at said network repository, a response associated with said request, said request and said response being stored in a document conforming to a CAB service handler application usage.

25. A method as defined in claim 24 wherein the document includes a unique identifier assigned to said request to associate said request with said response.

26. A method as defined in claim 24 wherein the CAB service feature corresponds to a CAB contact share function, and the request includes:
a recipient or list of recipients with which contact data is to be shared; and
an indication of the contact data to be shared.

27. A method as defined in claim 26 wherein the indication of the contact data to be shared specifies at least one of personal contact card data or a reference to address book contact entry data.

28. A method as defined in claim 26 wherein the request further includes:
a status of delivering the contact data associated with said request to one or more recipients, the status to be set to read-only for a CAB client making the request, the status to be updateable by a CAB server.

29. A method as defined in claim 24 wherein the CAB service feature corresponds to a CAB import address book function, and the request includes:
a domain name of a non-CAB system from which non-CAB address book data is to be imported; and
a credential for accessing the non-CAB system.

30. A method as defined in claim 29 wherein the credential is a username and a password for accessing the non-CAB system.

31. A method as defined in claim 29 wherein the request further includes:
an indication of whether the non-CAB address book data is to be updated periodically or whether said request is a one-time request.

32. A method as defined in claim 24 wherein retrieving said request from the network repository comprises at least one of (1) using a subscription procedure to cause a notification to be sent to indicate when to retrieve said request from the network repository, or (2) polling for said response using an extensible markup language (XML) configuration access protocol (XCAP) message.

33. A method as defined in claim 24 wherein said response includes a status code which indicates whether at least one of (1) said request has been successfully processed by a CAB server, or (2) a processing error has occurred.

34. A method as defined in claim 24 wherein the network repository is implemented by an XML document management server.

35. A tangible article of manufacture storing machine readable instructions which, when executed, cause a machine to implement the method defined in claim 24.

36-45. (canceled)

46. A method comprising:
managing a document associated with a converged address book (CAB) service by including in the document a request identifying a CAB service feature, the document conforming to a CAB service handler application usage, the document to support at least one of a CAB contact share function or a CAB import address book function; and
updating the document to include a response associated with said request.

47. A method as defined in claim 46 wherein the document includes a unique identifier assigned to said request to associate said request with said response.

48. A method as defined in claim 46 wherein the CAB service feature corresponds to the CAB contact share function, and the request includes:
a recipient or list of recipients with which contact data is to be shared; and
an indication of the contact data to be shared.

49. A method as defined in claim 48 wherein the indication of the contact data to be shared specifies at least one of personal contact card data or a reference to address book contact entry data.

50. A method as defined in claim 48 wherein the request further includes:
a status of delivering the contact data associated with said request to one or more recipients, the status to be set to read-only for a CAB client making the request, the status to be updateable by a CAB server.

51. A method as defined in claim 46 wherein the CAB service feature corresponds to the CAB import address book function, and the request includes:
a domain name of a non-CAB system from which non-CAB address book data is to be imported; and
a credential for accessing the non-CAB system.

52. A method as defined in claim 51 wherein the credential is a username and a password for accessing the non-CAB system.

53. A method as defined in claim 51 wherein the request further includes:
an indication of whether the non-CAB address book data is to be updated periodically or whether said request is a one-time request.

54. A method as defined in claim 46 wherein said response includes a status code which indicates whether at least one of (1) said request has been successfully processed by a CAB server, or (2) a processing error has occurred.

55. A method as defined in claim 46 wherein the method is performed by an extensible markup language (XML) document management server.

56. A tangible article of manufacture storing machine readable instructions which, when executed, cause a machine to implement the method defined in claim 46.

57-65. (canceled)
